(19) United States
(12) Patent Application Publication
(10) Pub. No.: US 2025/0167592 A1
(43) Pub. Date: May 22, 2025

(54) COIL COMPONENT AND WIRELESS POWER TRANSMITTING DEVICE HAVING THE SAME

(71) Applicant: TDK Corporation, Tokyo (JP)

(72) Inventors: Michihisa TOKUI, Tokyo (JP); Kentaro KAMIYAMA, Tokyo (JP); Sumin Kumar CHALISE, Tokyo (JP)

(21) Appl. No.: 18/951,803

(22) Filed: Nov. 19, 2024

(30) Foreign Application Priority Data
Nov. 20, 2023 (JP) 2023-196862
Sep. 30, 2024 (JP) 2024-170947

(51) Int. Cl. H02J 50/10; H01F 27/30

(52) U.S. Cl. CPC H02J 50/10; H01F 27/30

(57) ABSTRACT

Disclosed herein is a coil component that includes a first magnetic body, a first coil disposed so as to overlap the first magnetic body, a second coil having an outer size smaller than an outer size of the first coil and disposed so as to overlap the first coil, and a second magnetic body having an outer size smaller than the outer size of the first coil and disposed between the first and second coils.

### CROSS-REFERENCE TO RELATED APPLICATION

This application claims the benefit of Japanese Patent Application No. 2023-196862, filed on Nov. 20, 2023 and Japanese Patent Application No. 2024-170947, filed on Sep. 30, 2024, the entire disclosure of which are incorporated by reference herein.

### BACKGROUND

The present disclosure relates to a coil component and a wireless power transmitting device having the same.

Japanese Patent No. 7,232,960 discloses a coil component for a wireless power transmitting device.

The coil component described in Japanese Patent No. 7,232,960 has a problem in that, when an area (charge area) where wireless power transmission can be performed is widen, transmission efficiency at the center of the charge area lowers.

### SUMMARY

A coil component according to an embodiment of the present disclosure includes: a first magnetic body; a first coil disposed on the first magnetic body; a second coil having an outer size smaller than an outer size of the first coil and disposed on the first coil; and a second magnetic body having an outer size smaller than the outer size of the first coil and disposed between the first and second coils.

### BRIEF DESCRIPTION OF THE DRAWINGS

The above features and advantages of the present disclosure will be more apparent from the following description of certain some embodiments taken in conjunction with the accompanying drawings, in which:

FIG. 1 is a schematic cross-sectional view for explaining the structure of a coil component 1 according to a first embodiment of the present disclosure;

FIG. 2 is a schematic plan view of the coil component 1 as viewed in the coil axis direction;

FIG. 3 is a schematic plan view illustrating the shape of the conductor pattern formed on the surface 11 of the substrate 10;

FIG. 4 is a schematic plan view illustrating the shape of the conductor pattern formed on the surface 12 of the substrate 10, which illustrates a state viewed from the surface 11 side of the substrate 10 transparently through the substrate 10;

FIG. 5 is a schematic plan view illustrating the shape of the conductor pattern formed on the surface 21 of the substrate 20;

FIG. 6 is a schematic plan view illustrating the shape of the conductor pattern formed on the surface 22 of the substrate 20, which illustrates a state viewed from the surface 21 side of the substrate 20 transparently through the substrate 20;

FIG. 7 is a schematic view for explaining an example of the planar positional relationship between the first coil C1, second coil C2, first magnetic body 31, and second magnetic body 32;

FIG. 8 is a graph illustrating the relationship between the size of the second magnetic body 32 and the magnetic field strength;

FIG. 9 is a schematic cross-sectional view for explaining the structure of a coil component 2 according to a second embodiment of the present disclosure;

FIG. 10 is a schematic view for explaining the planar positional relationship between the first coil C1, second coil C2, first magnetic body 31, and second magnetic body 32 in the second embodiment;

FIG. 11 is a schematic view illustrating the positional relationship between the coil component 2 according to the second embodiment and a smartphone in a charge system for the smartphone;

FIG. 12 is a block diagram illustrating a wireless power transmitting device 70 using the coil component 1 or coil component 2; and

FIG. 13 is a block diagram illustrating a wireless power transmitting device 80 using the coil component 1 or coil component 2.

### DETAILED DESCRIPTION OF THE EMBODIMENTS

An object of the present disclosure is to provide a coil component having improved transmission efficiency at the center of the charge area without reducing the size of the charge area and a wireless power transmitting device having the same.

Some embodiments of the present disclosure will be explained below in detail with reference to the accompanying drawings.

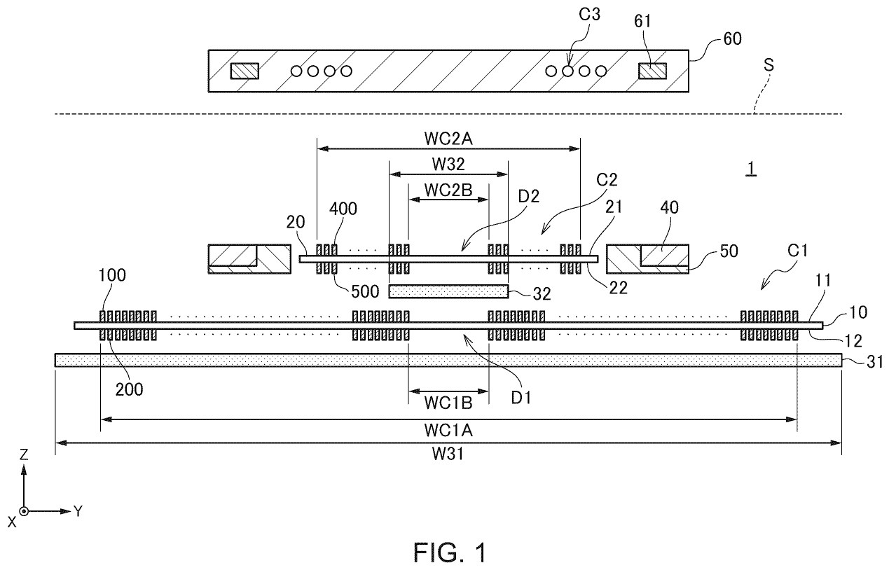

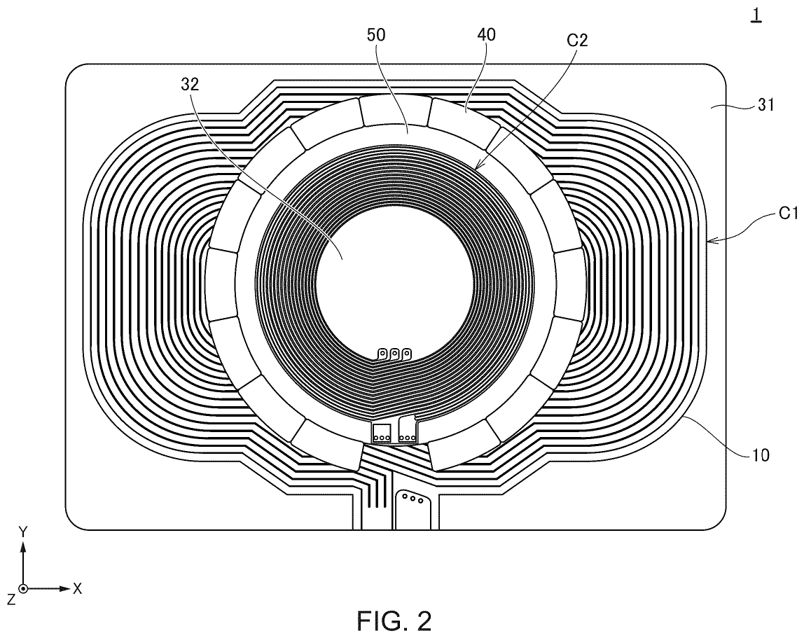

FIG. 1 is a schematic cross-sectional view for explaining the structure of a coil component 1 according to a first embodiment of the present disclosure. FIG. 2 is a schematic plan view of the coil component 1 as viewed in the coil axis direction. FIG. 1 illustrates a typical cross section taken along the line extending in the Y-direction passing the center of the coil component 1 of FIG. 2.

As illustrated in FIGS. 1 and 2, the coil component 1 according to an embodiment includes a first magnetic body 31, a first coil C1 disposed on the first magnetic body 31, a second coil C2 disposed on the first coil C1, a second magnetic body 32 disposed between the first and second coils C1 and C2, and a magnet 40 disposed radially outside the second coil C2. The first coil C1 is composed of coil patterns 100 and 200 respectively provided on surfaces 11 and 12 of a substrate 10 made of a PET film or the like. The second coil C2 is composed of coil patterns 400 and 500 respectively provided on surfaces 21 and 22 of a substrate 20 made of a PET film or the like. Although, for descriptive convenience, there is provided a gap between members constituting the coil component 1 in FIG. 1, these members may be fixed to one another using a not-shown adhesive sheet. Specifically, for example, the first coil C1 may be adhesively fixed to the first magnetic body 31 through a not-shown adhesive sheet, the second magnetic body 32 may be adhesively fixed to the first coil C1 through a not-shown adhesive sheet, and the second coil C2 and the magnet 40 may be adhesively fixed respectively to the second magnetic body 32 and the first coil C1 through a not-shown adhesive sheet.

Both the first and second coils C1 and C2 function as a power transmitting coil for wireless power transmission. The coil axis direction of the first and second coils C1 and C2 is the Z-direction. The first magnetic body 31, first coil C1, second magnetic body 32, and second coil C2 are stacked in this order in the Z-direction. The first and second magnetic bodies 31 and 32 may each be made of a sheet-like magnetic material having a relative permeability of 300 or more. When a power transmission frequency using the first and second coils C1 and C2 is about 100 kHz to 200 kHz, using a magnetic material having a relative permeability of 300 or more as a material for the first and second magnetic bodies 31 and 32 allows achievement of high inductance. On the other hand, information communication using a coil, such as near field communication (NFC), which generally uses MHz bands as the communication frequency, undergoes a large loss when using a magnetic material having a relative permeability of 300 or more.

In actual use, an electronic device 60 including a power receiving coil C3 is placed on a mounting surface S illustrated in FIG. 1, and the first coil C1 or second coil C2 functioning as a power transmitting coil and the power receiving coil C3 are coupled to each other, whereby power is wirelessly transmitted from the coil component 1 to the electronic device 60. The first and second magnetic bodies 31 and 32 function as magnetic paths for magnetic flux generated by the first and second coils C1 and C2. The first coil C1 is mainly used for ensuring a wide charge area, and the second coil C2 is mainly used for improving transmission efficiency at the center of the charge area.

An outer size WC2A of the second coil C2 is smaller than an outer size WC1A of the first coil C1. The outer size WC1A is the radial size of the first coil C1. As illustrated in FIG. 2, the outer size WC1A in the Y-direction may be smaller than the outer size WC1A in the X-direction. In this case, the outer size WC1A of the first coil C1 may be defined by the Y-direction size having the smallest value. The outer size WC2A is the radial size of the second coil C2. Although the second coil C2 has a circular outer shape in the example illustrated in FIG. 2, it may have a shape in which the outer size WC2A changes depending on directions like the first coil C1.

The first and second coils C1 and C2 may be arranged such that a first opening area D1 surrounded by the winding area of the first coil C1 and a second opening area D2 surrounded by the winding area of the second coil C2 overlap each other in the Z-direction. The winding area of the first coil C1 refers to an area where a conductor pattern constituting the first coil C1 exists, which is positioned between the innermost and outermost turns of the first coil C1. Similarly, the winding area of the second coil C2 refers to an area where a conductor pattern constituting the second coil C2 exists, which is positioned between the innermost and outermost turns of the second coil C2. In this case, the center axes of the first and second coils C1 and C2 may coincide in position with each other. A size WC1B of the first opening area D1 and a size WC2B of the second opening area D2 may differ from each other.

The size WC1B of the first opening area D1 may be different in the X- and Y-directions. In this case, the size WC1B of the first opening area D1 may be defined by the smallest size in the radial direction. On the other hand, the shape of the second opening area D2 is a circular shape like the outer shape of the second coil C2 with the same size in the X- and Y-directions; however, the second opening area D2 may have different sizes in the X- and Y-directions. In this case, the size WC2B of the second opening area D2 may be defined by the smallest size in the radial direction. The second magnetic body 32 may be disposed so as to overlap both the first and second opening areas D1 and D2.

An outer size W31 of the first magnetic body 31 is larger than the outer size WC1A of the first coil C1, and thus the first coil C1 entirely overlaps the first magnetic body 31 in the Z-direction. An outer size W32 of the second magnetic body 32 is smaller than the outer size WC1A of the first coil C1, and thus at least a part of the first coil C1 does not overlap the second magnetic body 32 in the Z-direction. The second magnetic body 32 is positioned between the first coil C1 and the mounting surface S, so that when the first coil C1 is completely covered with the second magnetic body 32, power transmission efficiency lowers; however, in the present embodiment, the outer size W32 of the second magnetic body 32 is smaller than the outer size WC1A of the first coil C1, so that the first coil C1 is suppressed from being blocked by the second magnetic body 32, thus enabling power transmission using the first coil C1. The outer size W32 of the second magnetic body 32 may be smaller than the outer size WC2A of the second coil C2. In this case, at least a part of the second coil C2 does not overlap the second magnetic body 32 in the Z-direction. As illustrated in FIG. 2, the outer size W31 of the first magnetic body 31 may be smaller in the X-direction than in the Y-direction correspondingly to the difference in outer size WC1A in the radial direction of the first coil C1. In this case, the outer size W31 of the first magnetic body 31 may be defined by the smallest size in the Y-direction. Further, the shape of the second magnetic body 32 may be a circular shape corresponding to the outer shape of the second coil C2.

The magnet 40 is annularly disposed along the outer shape of the second coil C2 so as not to overlap the same. The magnet 40 may be disposed in a complete ring shape or in a state as illustrated in FIG. 2 where the ring shape around the second coil C2 is partially removed. The magnet 40 has a fixed positional relation at least in the XY plane direction with the second coil C2 and positions the second coil C2 and power receiving coil C3 using attraction force acting between itself and a magnet 61 provided in the electronic device 60. In the example illustrated in FIGS. 1 and 2, the magnet 40 is supported by a support member 50 made of resin or the like. The magnet 40 may be disposed so as to entirely overlap the winding area of the first coil C1. When the magnet 40 is made to entirely overlap the winding area of the first coil C1, the first opening area D1 with a high magnetic flux density is not covered with the magnet 40, making it possible to suppress a loss due to the presence of the magnet 40.

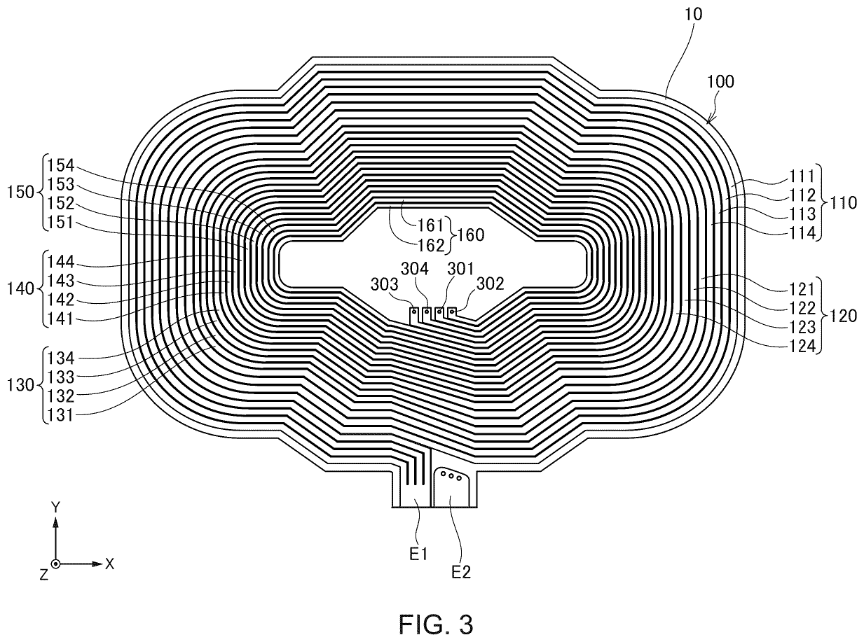

FIG. 3 is a schematic plan view illustrating the shape of the conductor pattern formed on the surface 11 of the substrate 10.

As illustrated in FIG. 3, a coil pattern 100 constituting a part of the first coil C1 and terminal electrodes E1, E2 are formed on the surface 11 of the substrate 10. The coil pattern 100 has a six-turn configuration constituted of turns 110, 120, 130, 140, 150, and 160. The turn 110 is positioned at the outermost periphery, and the turn 160 is positioned at the innermost periphery. The turns 110, 120, 130, 140, and 150 are each radially divided into four lines by three spiral slits.

The turn 160 is radially divided into two lines by one spiral slit. As a result, the turn 110 is divided into four lines 111 to 114, the turn 120 is divided into four lines 121 to 124, the turn 130 is divided into four lines 131 to 134, the turn 140 is divided into four lines 141 to 144, the turn 150 is divided into four lines 151 to 154, and the turn 160 is divided into two lines 161 and 162.

The lines 111, 121, 131, 141, 151, and 161 constitute a continuous line spirally wound in six turns and are each positioned at the outermost periphery in its corresponding turn. The lines 112, 122, 132, 142, 152, and 162 constitute a continuous line spirally wound in six turns and are each the second line counted from the outermost peripheral line in its corresponding turn. The lines 113, 123, 133, 143, and 153 constitute a continuous line spirally wound in five turns and are each the second line counted from the innermost peripheral line in its corresponding turn. The lines 114, 124, 134, 144, and 154 constitute a continuous line spirally wound in five turns and are each positioned at the innermost periphery in its corresponding turn.

The outer peripheral ends of the lines 111 to 114 are connected in common to the terminal electrode E1. The inner peripheral ends of the lines 161, 162, 153, and 154 are connected respectively to through hole conductors 301 to 304 penetrating the substrate 10.

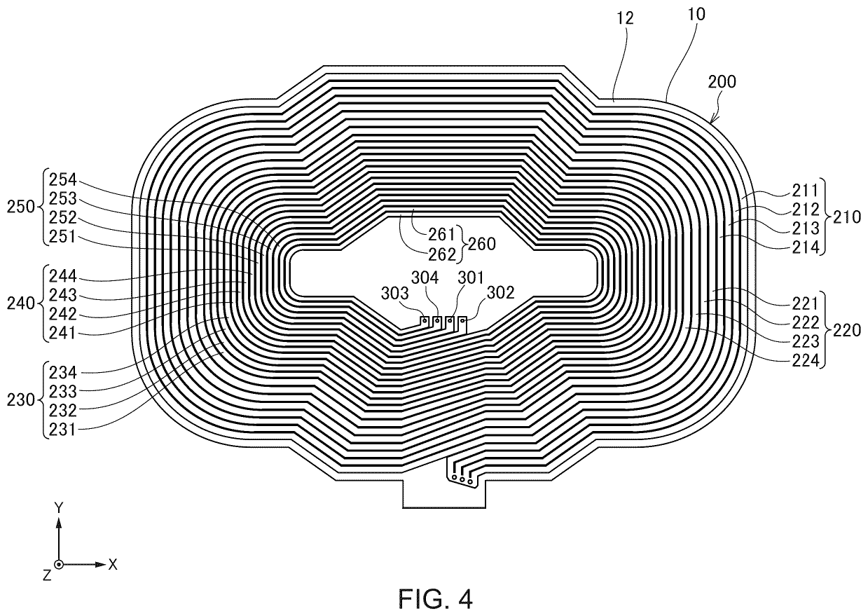

FIG. 4 is a schematic plan view illustrating the shape of the conductor pattern formed on the surface 12 of the substrate 10, which illustrates a state viewed from the surface 11 side of the substrate 10 transparently through the substrate 10.

As illustrated in FIG. 4, a coil pattern 200 constituting the remaining part of the first coil C1 is formed on the surface 12 of the substrate 10. The coil pattern 200 has basically the same pattern shape as the coil pattern 100. The coil pattern 200 has a six-turn configuration constituted of turns 210, 220, 230, 240, 250, and 260. The turn 210 is positioned at the outermost periphery, and the turn 260 is positioned at the innermost periphery. The turns 210, 220, 230, 240, and 250 are each radially divided into four lines by three spiral slits. The turn 260 is radially divided into two lines by one spiral slit. As a result, the turn 210 is divided into four lines 211 to 214, the turn 220 is divided into four lines 221 to 224, the turn 230 is divided into four lines 231 to 234, the turn 240 is divided into four lines 241 to 244, the turn 250 is divided into four lines 251 to 254, and the turn 260 is divided into two lines 261 and 262.

The lines 211, 221, 231, 241, 251, and 261 constitute a continuous line spirally wound in six turns and are each positioned at the outermost periphery in its corresponding turn. The lines 212, 222, 232, 242, 252, and 262 constitute a continuous line spirally wound in six turns and are each the second line counted from the outermost peripheral line in its corresponding turn. The lines 213, 223, 233, 243, and 253 constitute a continuous line spirally wound in five turns and are each the second line counted from the innermost peripheral line in its corresponding turn. The lines 214, 224, 234, 244, and 254 constitute a continuous line spirally wound in five turns and are each positioned at the innermost periphery in its corresponding turn.

The outer peripheral ends of the lines 211 to 214 are connected in common to the terminal electrode E2 through through hole conductors. The inner peripheral ends of the lines 261, 262, 253, and 254 are connected respectively to through hole conductors 304, 303, 302, and 301. As a result, the first coil C1 having a configuration in which four lines each having 11 turns are connected in parallel is connected between the terminal electrodes E1 and E2. Thus, the first coil C1 is a flat spiral coil.

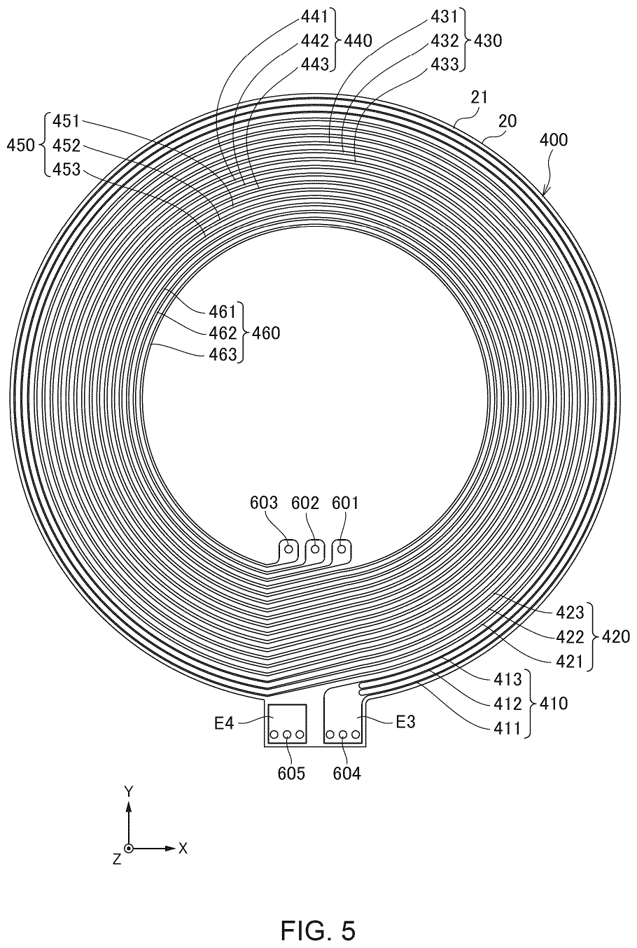

FIG. 5 is a schematic plan view illustrating the shape of the conductor pattern formed on the surface 21 of the substrate 20.

As illustrated in FIG. 5, a coil pattern 400 constituting a part of the second coil C2 and a terminal electrode E3 are formed on the surface 21 of the substrate 20. The coil pattern 400 has a six-turn configuration constituted of turns 410, 420, 430, 440, 450, and 460. The turn 410 is positioned at the outermost periphery, and the turn 460 is positioned at the innermost periphery. The turns 410, 420, 430, 440, 450 and 460 are each radially divided into three lines by two spiral slits. As a result, the turn 410 is divided into three lines 411 to 413, the turn 420 is divided into three lines 421 to 423, the turn 430 is divided into three lines 431 to 433, the turn 440 is divided into three lines 441 to 443, the turn 450 is divided into three lines 451 to 453, and the turn 460 is divided into three lines 461 to 463.

The lines 411, 421, 431, 441, 451, and 461 constitute a continuous line spirally wound in six turns and are each positioned at the outermost periphery in its corresponding turn. The lines 412, 422, 432, 442, 452, and 462 constitute a continuous line spirally wound in six turns and are each the radially intermediate line in its corresponding turn. The lines 413, 423, 433, 443, 453, and 463 constitute a continuous line spirally wound in six turns and are each positioned at the innermost periphery in its corresponding turn.

The outer peripheral ends of the lines 411 to 413 are connected in common to the terminal electrode E3. The inner peripheral ends of the lines 461 to 463 are connected respectively to through hole conductors 601 to 603 penetrating the substrate 20.

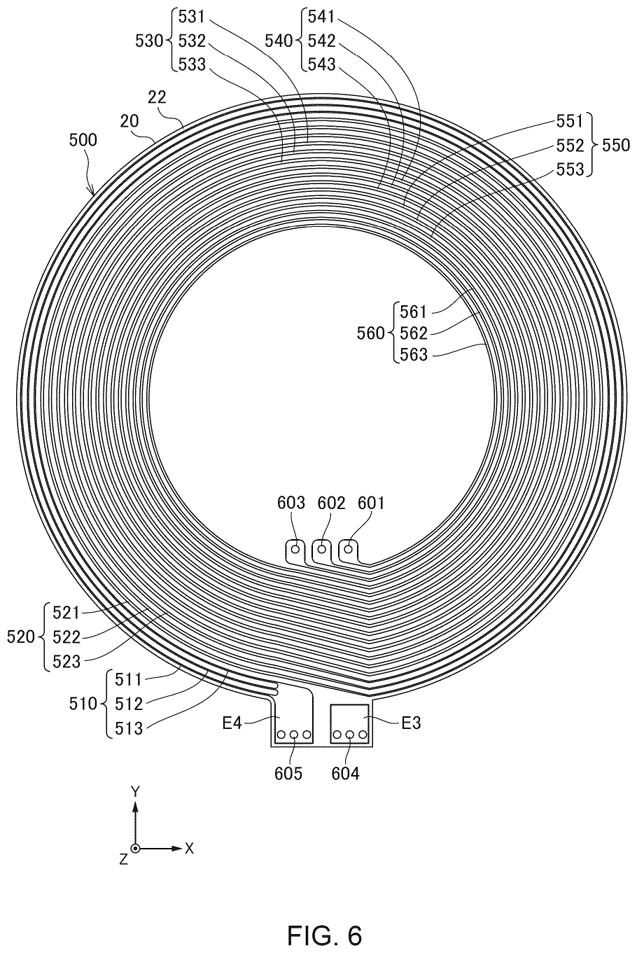

FIG. 6 is a schematic plan view illustrating the shape of the conductor pattern formed on the surface 22 of the substrate 20, which illustrates a state viewed from the surface 21 side of the substrate 20 transparently through the substrate 20.

As illustrated in FIG. 6, a coil pattern 500 constituting the remaining part of the second coil C2 is formed on the surface 22 of the substrate 20. The coil pattern 500 has basically the same pattern shape as the coil pattern 400. The coil pattern 500 has a six-turn configuration constituted of turns 510, 520, 530, 540, 550, and 560. The turn 510 is positioned at the outermost periphery, and the turn 560 is positioned at the innermost periphery. The turns 510, 520, 530, 540, 550 and 560 are each radially divided into three lines by two spiral slits. As a result, the turn 510 is divided into three lines 511 to 513, the turn 520 is divided into three lines 521 to 523, the turn 530 is divided into three lines 531 to 533, the turn 540 is divided into three lines 541 to 543, the turn 550 is divided into three lines 551 to 553, and the turn 560 is divided into three lines 561 to 563.

The lines 511, 521, 531, 541, 551, and 561 constitute a continuous line spirally wound in six turns and are each positioned at the outermost periphery in its corresponding turn. The lines 512, 522, 532, 542, 552, and 562 constitute a continuous line spirally wound in six turns and are each the radially intermediate line in its corresponding turn. The lines 513, 523, 533, 543, 553, and 563 constitute a continuous line spirally wound in six turns and are each positioned at the innermost periphery in its corresponding turn.

The outer peripheral ends of the lines 511 to 513 are connected in common to the terminal electrode E4. The inner peripheral ends of the lines 561 to 563 are connected respectively to through hole conductors 603, 602, and 601 penetrating the substrate 20. As a result, the second coil C2 having a configuration in which three lines each having 12 turns are connected in parallel is connected between the terminal electrodes E3 and E4. Thus, the second coil C2 is a flat spiral coil. The terminal electrode E3 is provided also on the surface 22 of the substrate 20, and the terminal electrodes E3 on the surfaces 21 and 22 are connected to each other through a through hole conductor 604. Similarly, the terminal electrode E4 is provided also on the surface 21 of the substrate 20, and the terminal electrodes E4 on the surfaces 21 and 22 are connected to each other through a through hole conductor 605.

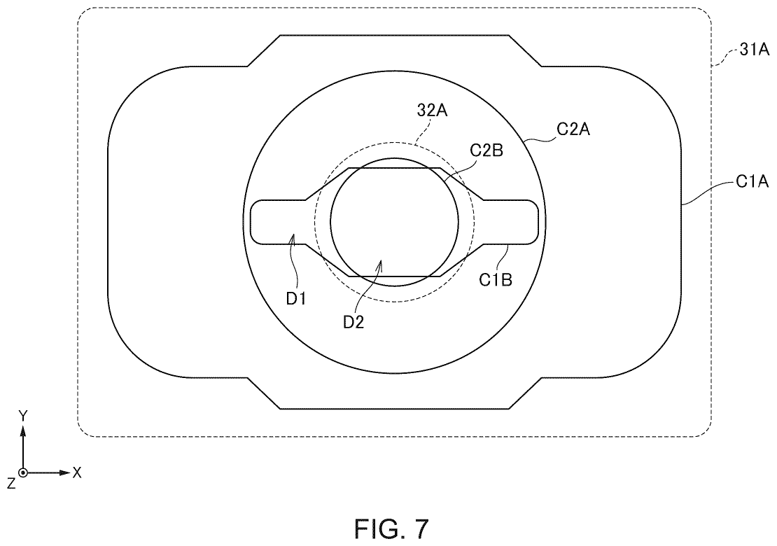

FIG. 7 is a schematic view for explaining an example of the planar positional relationship between the first coil C1, second coil C2, first magnetic body 31, and second magnetic body 32.

In FIG. 7, an outer peripheral edge CIA of the first coil C1, an inner peripheral edge C1B of the first coil C1, an outer peripheral edge C2A of the second coil C2, and an inner peripheral edge C2B of the second coil C2 are each denoted by a solid line, and an outer peripheral edge 31A of the first magnetic body 31 and an outer peripheral edge 32A of the second magnetic body 32 are each denoted by a dashed line.

In the example illustrated in FIG. 7, the entire outer peripheral edge C1A of the first coil C1 is positioned inside the outer peripheral edge 31A of the first magnetic body 31. In other words, the entire first coil C1 overlaps the first magnetic body 31 in the Z-direction. Further, the entire outer peripheral edge C2A of the second coil C2 is positioned inside the outer peripheral edge C1A of the first coil C1. However, the winding area of the second coil C2 partially overlaps the first opening area D1 of the first coil C1 in the Z-direction. The second coil C2 has a circular shape, while the first coil C1 has a planar shape having a longitudinal direction, and the first opening area D1 is also elongated in the longitudinal direction of the first coil C1.

In the example illustrated in FIG. 7, the first and second opening areas D1 and D2 overlap each other in the Z-direction. Specifically, a part of the first opening area D1 overlaps the second opening area D2, and the remaining part thereof overlaps the winding area of the second coil C2. Similarly, a part of the second opening area D2 overlaps the first opening area D1, and the remaining part thereof overlaps the winding area of the first coil C1.

In the example illustrated in FIG. 7, the outer and inner peripheral edges C1A and C1B of the first coil C1 both have a noncircular shape, while the outer and inner peripheral edges C2A and C2B of the second coil C2 and the outer peripheral edge 32A of the second magnetic body 32 all have a circular shape. The center axes of the first and second coils C1 and C2 may coincide with the center of the second magnetic body 32. In the example illustrated in FIG. 7, the entire second opening area D2 of the second coil C2 overlaps the second magnetic body 32 in the Z-direction. The second magnetic body 32 partially overlaps the winding area of the second coil C2. The first opening area D1 of the first coil C1 partially overlaps the second magnetic body 32 in the Z-direction, while the remaining part thereof does not overlap the same. The second magnetic body 32 partially overlaps the winding area of the first coil C1.

The second magnetic body 32 functions mainly as a magnetic path for magnetic flux generated by the second coil C2. The second magnetic body 32 is disposed on the side opposite to the mounting surface S with respect to the second coil C2, so that the larger the outer size W32 of the second magnetic body 32 is, the more the power transmission efficiency between the second coil C2 and the power receiving coil C3 improves. While the second magnetic body 32 functions also as a magnetic path for magnetic flux generated by the first coil C1, it is disposed closer to the mounting surface S than the first coil C1 is, so that as the outer size W32 of the second magnetic body 32 becomes larger, power transmission efficiency between the first coil C1 and the power receiving coil C3 lowers.

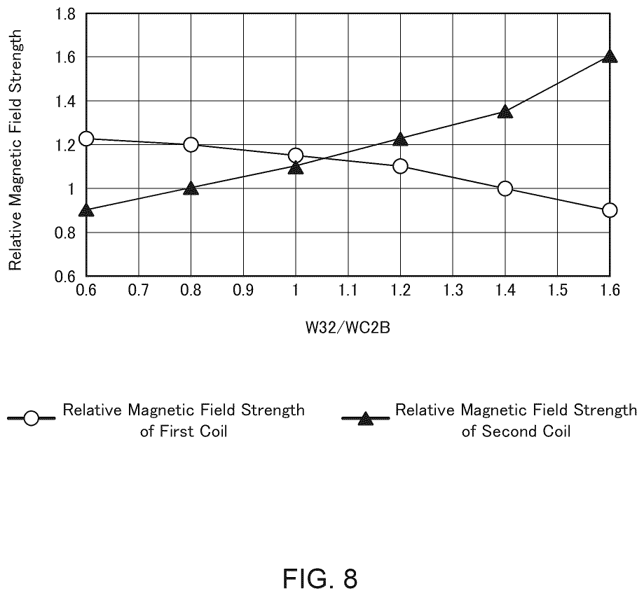

FIG. 8 is a graph illustrating the relationship between the size of the second magnetic body 32 and the magnetic field strength.

In FIG. 8, the horizontal axis represents the ratio (W32/WC2B) of the outer size W32 of the second magnetic body 32 to the size WC2B of the second opening area D2, and the vertical axis represents the relative magnetic field strength of the first and second coils C1 and C2. The relative magnetic field strength refers to the relative strength of a magnetic field that reaches the power receiving coil C3 when a unit current is made to flow in the first coil C1 or second coil C2 as a power transmitting coil and is required to have a value of 1 or more for satisfactory power transmission.

As illustrated in FIG. 8, the magnetic field strength of the second coil C2 becomes higher as the outer size W32 of the second magnetic body 32 becomes larger, and when the value of W32/WC2B is 0.8 or more, the standardized value of the magnetic field strength of the second coil C2 becomes 1 or more. Considering this, the outer size W32 of the second magnetic body may be 0.8 times or more the size of the second opening area D2. In particular, when the outer size W32 of the second magnetic body is larger than the size of the second opening area D2, higher power transmission coefficient can be achieved. In this case, when the center axis of the second coil C2 and the center of the second magnetic body 32 coincide with each other, the second magnetic body 32 overlaps the entire second opening area D2. Accordingly, all magnetic fluxes that pass through the second opening area D2 pass through the second magnetic body 32, making it possible to achieve high inductance.

On the other hand, the magnetic field strength of the first coil C1 becomes lower as the outer size W32 of the second magnetic body 32 becomes larger, and when the value of W32/WC2B exceeds 1.4, the standardized value of the magnetic field strength of the first coil C1 becomes less than 1. Considering this, the outer size W32 of the second magnetic body may be 1.4 times or less the size of the second opening area D2.

As described above, in the coil component 1 according to the present embodiment, the first coil C1 whose outer size WC1A is large and the second coil C2 whose outer size WC2A is smaller than the outer size WC1A are disposed so as to overlap each other, whereby it is possible to prevent lowering of transmission efficiency at the center of the charge area without reducing the size of the charge area. In addition, the presence of the second magnetic body 32 between the first and second coils C1 and C2 improves the power transmission efficiency of the second coil C2. Further, the outer size W32 of the second magnetic body 32 is smaller than the outer size WC1A of the first coil C1, so that the first coil C1 is suppressed from being blocked by the second magnetic body 32, thus enabling power transmission using the first coil C1.

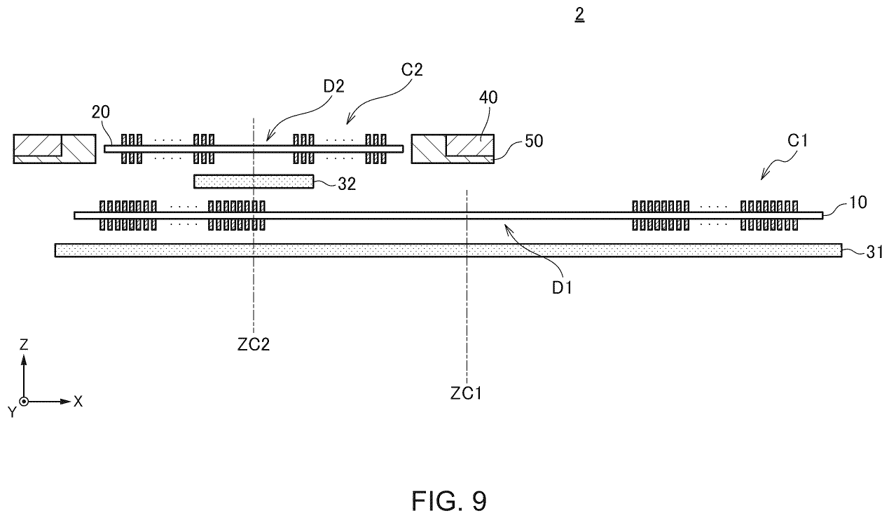

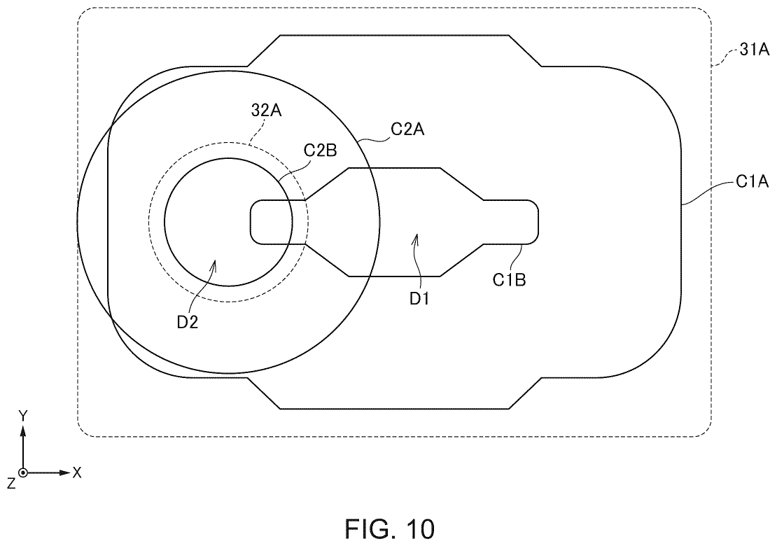

FIG. 9 is a schematic cross-sectional view for explaining the structure of a coil component 2 according to a second embodiment of the present disclosure. FIG. 10 is a schematic view for explaining the planar positional relationship between the first coil C1, second coil C2, first magnetic body 31, and second magnetic body 32 in the second embodiment.

As illustrated in FIGS. 9 and 10, the coil component 2 according to the present embodiment is featured in that the coil axes of the first and second coils C1 and C2 do not coincide with each other. More specifically, the position of the coil axis ZC2 of the second coil C2 is offset from the center position of the first coil C1 in the longitudinal direction thereof to one side in the longitudinal direction of the first coil C1. The coil axis of the second coil C2 may overlap the winding area of the first coil C1 or may overlap the first opening area D1 of the first coil C1. Other configurations are the same as those of the coil component 1 according to the first embodiment.

In the example illustrated in FIG. 10, the entire outer peripheral edge CIA of the first coil C1 is positioned inside the outer peripheral edge 31A of the first magnetic body 31. In other words, the entire first coil C1 overlaps the first magnetic body 31 in the Z-direction. Further, the outer peripheral edge C2A of the second coil C2 may be entirely positioned inside the outer peripheral edge C1A of the first coil C1 or may be partially positioned outside the outer peripheral edge C1A of the first coil C1.

In the example illustrated in FIG. 10, the first and second opening areas D1 and D2 overlap each other in the Z-direction. Specifically, a part of the second opening area D2 overlaps an end portion of the first opening area D1 on one side in the longitudinal direction thereof, and the remaining part of the second opening area D2 overlaps the first coil C1. A part of the winding area of the second coil C2 overlaps the first opening area D1 of the first coil C1 in the Z-direction. The other end portion of the first opening area D1 in the longitudinal direction thereof does not overlap the winding area of the second coil C2.

In the example illustrated in FIG. 10, the outer and inner peripheral edges C1A and C1B of the first coil C1 both have a noncircular shape and has a longitudinal direction, while the outer and inner peripheral edges C2A and C2B of the second coil C2 and the outer peripheral edge 32A of the second magnetic body 32 all have a circular shape. The coil axis of the second coil C2 coincides with the center of the second magnetic body 32, while the coil axis of the first coil C1 does not coincide with the second magnetic body 32. The second magnetic body 32 partially overlaps the winding area of the second coil C2. An end portion of the first opening area D1 of the first coil C1 on one side in the longitudinal direction thereof overlaps the second magnetic body 32 in the Z-direction, and the remaining part of the first opening area D1 does not overlap the second magnetic body 32. The second magnetic body 32 partially overlaps the winding area of the first coil C1.

As described above, in the coil component 2 according to the present embodiment, the position of the coil axis of the second coil C2 is offset from the center position of the first coil C1 in the longitudinal direction thereof, so that the center of the charge area can be shifted from the center of the first coil C1. Thus, even when the power receiving coil C3 is shifted from the center of the coil component 2, it is possible to prevent lowering of the efficiency of power transmission to the power receiving coil C3.

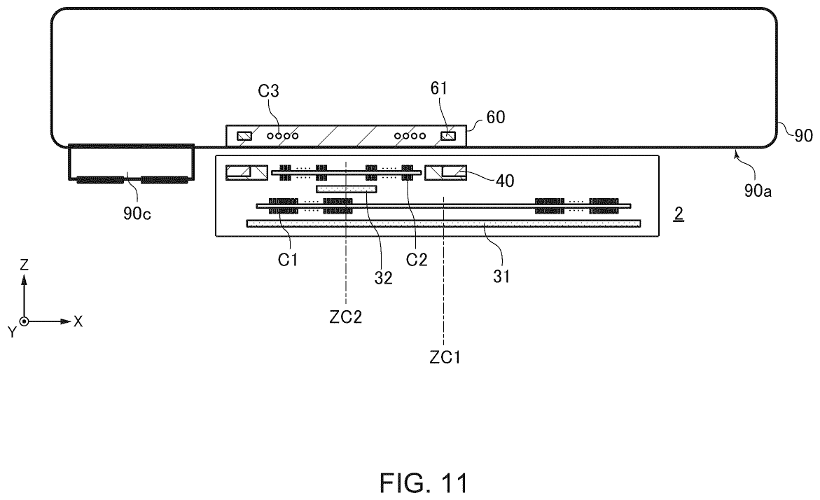

FIG. 11 is a schematic view illustrating the positional relationship between the coil component 2 according to the second embodiment and a smartphone in a charge system for the smartphone.

As illustrated in FIG. 11, when the electronic device 60 including the power receiving coil C3 constitutes a part of a smartphone 90, the first coil C1 or second coil C2 functioning as a power transmitting coil and the power receiving coil C3 are coupled to each other, whereby power is wirelessly transmitted from the coil component 2 to the electronic device 60, and the power is charged in a battery (not illustrated) incorporated in the smartphone 90.

In many cases, the smartphone 90 is provided with a camera lens 90c on its back surface 90a side, and recently, there are cases where the camera lens 90c significantly protrudes from the back surface 90a. When such a protruding part exists on the back surface 90a of the smartphone 90, a housing accommodating the coil component 2 interferes with the camera lens 90c of the smartphone 90. In this case, depending on the position of the power receiving coil C3 in the smartphone 90, the coil axis of the power receiving coil C3 on the smartphone 90 side cannot be made to coincide with the center of the transmission side coil component 2. Further, even if a magnet 61 for positioning is provided in the electronic device 60, it may fail to effectively function due to interference with the camera lens 90c.

However, in the present embodiment, the coil axis of the second coil C2 in the coil component 2 is offset with respect to the first coil C1, so that even when the power receiving coil C3 is shifted from the center of the coil component 1, lowering of the efficiency of power transmission to the power receiving coil C3 can be prevented. In other words, the coil axis of the power receiving coil C3 need not coincide with the coil axis of the first coil C1 but only needs to coincide with the coil axis of the second coil C2 disposed in an offset manner, thus making it possible to improve charge efficiency of the smartphone 90.

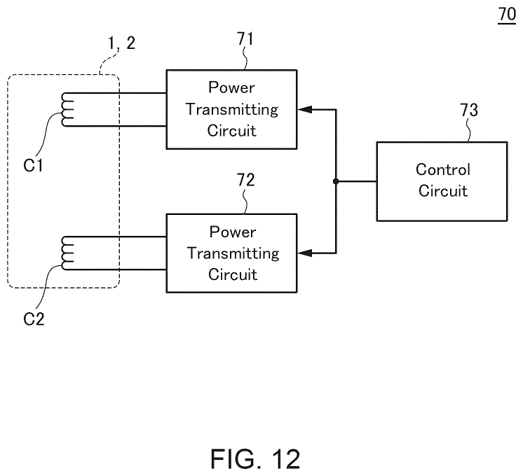

FIG. 12 is a block diagram illustrating a wireless power transmitting device 70 using the coil component 1 or coil component 2.

The wireless power transmitting device 70 illustrated in FIG. 12 includes the coil component 1 or coil component 2 having the first and second coils C1 and C2, a power transmitting circuit 71 connected to the first coil C1, a power transmitting circuit 72 connected to the second coil C2, and a control circuit 73 for controlling the power transmitting circuits 71 and 72. The control circuit 73 exclusively activates one of the power transmitting circuits 71 and 72. This enables power transmission using the first coil C1 or power transmission using the second coil C2.

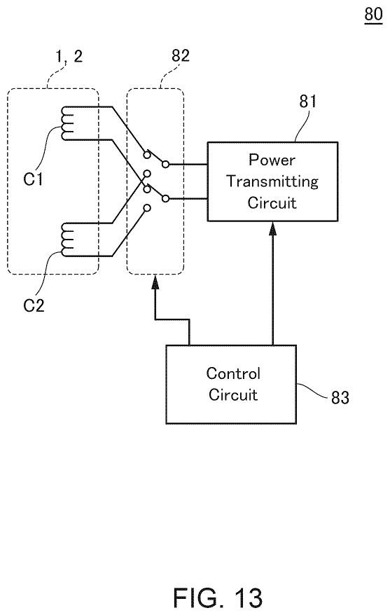

FIG. 13 is a block diagram illustrating a wireless power transmitting device 80 using the coil component 1 or coil component 2.

The wireless power transmitting device 80 illustrated in FIG. 13 includes the coil component 1 or coil component 2 having the first and second coils C1 and C2, a power transmitting circuit 81 connected to the first and second coils C1 and C2, a switch 82 connected between the first and second coils C1 and C2 and the power transmitting circuit 81, and a control circuit 83 for controlling the power transmitting circuit 81 and switch 82. The control circuit 83 performs switching of the switch 82 to connect one of the first and second coils C1 and C2 to the power transmitting circuit 81. This enables power transmission using the first coil C1 or power transmission using the second coil C2.

While some embodiment of the present disclosure has been described, the present disclosure is not limited to the above embodiment, and various modifications may be made within the scope of the present disclosure, and all such modifications are included in the present disclosure.

For example, the first and second coils C1 and C2 may each constituted by a coated conductive wire not by a conductor pattern formed on the surface of the substrate. Further, the conductor patterns formed on the surfaces 11, 12 of the substrate 10 and on the surfaces 21, 22 of the substrate 20 may be provided thereon through a material layer containing resin.

The technology according to the present disclosure includes the following configuration examples but not limited thereto.

A coil component according to an embodiment of the present disclosure includes: a first magnetic body; a first coil disposed on the first magnetic body; a second coil having an outer size smaller than an outer size of the first coil and disposed on the first coil; and a second magnetic body having an outer size smaller than the outer size of the first coil and disposed between the first and second coils. With this configuration, it is possible to prevent lowering of transmission efficiency at the center of the charge area without reducing the size of the charge area.

In the above coil component, the first and second coils may be arranged such that a first opening area surrounded by the winding area of the first coil and a second opening area surrounded by the winding area of the second coil overlap each other, and the second magnetic body may be disposed so as to overlap the first and second opening areas. This makes it possible to make more magnetic flux pass through the second magnetic body, thus achieving high inductance.

In the above coil component, the outer size of the second magnetic body may be smaller than that of the second coil. This can prevent lowering of the transmission efficiency of the first coil.

In the above coil component, the outer size of the second magnetic body may be 0.8 times or more to 1.4 times or less the size of the second opening area. This can improve the transmission efficiency of both the first and second coils.

In the above coil component, the outer size of the second magnetic body may be larger than the size of the second opening area. This can improve transmission efficiency at the center of the charge area.

In the above coil component, the second magnetic body may overlap the entire second opening area. This can further improve transmission efficiency at the center of the charge area.

In the above coil component, the second magnetic body may overlap a part of the winding area of the first coil and may not overlap a part of the first opening area. This can improve the transmission efficiency of both the first and second coils.

In the above coil component, the relative permeability of the first magnetic body may be 300 or more. This allows a power transmitting frequency using the first coil to be set to a frequency suitable for wireless power transmission.

In the above coil component, the relative permeability of the second magnetic body may be 300 or more. This allows a power transmitting frequency using the second coil to be set to a frequency suitable for wireless power transmission.

The above coil component may further include a magnet disposed along the outer shape of the second coil. This allows positioning of the coil component with respect to a power receiving coil.

In the above coil component, the magnet may entirely overlap the winding area of the first coil. This can suppress the loss of the first coil due the presence of the magnet.

In the above coil component, the planar shape of the first coil may have a longitudinal direction, and the position of the coil axis of the second coil may be offset from the center position of the first coil in the longitudinal direction thereof to one side in the longitudinal direction of the first coil. Thus, even when a power receiving coil is shifted from the center of the coil component, it is possible to prevent lowering of the efficiency of power transmission to the power receiving coil.

In the above coil component, the first opening area surrounded by the winding area of the first coil may be elongated in the longitudinal direction of the first coil, and the second opening area surrounded by the winding area of the second coil may overlap an end portion of the first opening area on one side in the longitudinal direction. Even in such a configuration, lowering of the efficiency of power transmission to a power receiving coil can be prevented.

In the above coil component, the coil axis of the second coil may overlap the winding area of the first coil. Even in such a configuration, lowering of the efficiency of power transmission to a power receiving coil can be prevented.

A wireless power transmitting device according to an embodiment of the present disclosure includes any of the above coil components and a power transmitting circuit connected to the first and second coils. Thus, there can be provided a wireless power transmitting device having a wide charge area and achieving improved transmission efficiency at the center of the charge area.

What is claimed is:

1. A coil component comprising:
a first magnetic body;
a first coil disposed so as to overlap the first magnetic body;
a second coil having an outer size smaller than an outer size of the first coil and disposed so as to overlap the first coil; and
a second magnetic body having an outer size smaller than the outer size of the first coil and disposed between the first and second coils.

2. The coil component as claimed in claim 1,
wherein the first and second coils are arranged such that a first opening area surrounded by a winding area of the first coil and a second opening area surrounded by a winding area of the second coil overlap each other, and
wherein the second magnetic body is disposed so as to overlap the first and second opening areas.

3. The coil component as claimed in claim 2, wherein the outer size of the second magnetic body is smaller than that of the second coil.

4. The coil component as claimed in claim 3, wherein the outer size of the second magnetic body is 0.8 times or more to 1.4 times or less a size of the second opening area.

5. The coil component as claimed in claim 4, wherein the outer size of the second magnetic body is larger than the size of the second opening area.

6. The coil component as claimed in claim 5, wherein the second magnetic body overlaps an entire second opening area.

7. The coil component as claimed in claim 2, wherein the second magnetic body overlaps a part of the winding area of the first coil and does not overlap a part of the first opening area.

8. The coil component as claimed in claim 1, wherein a relative permeability of the first magnetic body is 300 or more.

9. The coil component as claimed in claim 8, wherein a relative permeability of the second magnetic body is 300 or more.

10. The coil component as claimed in claim 1, further comprising a magnet disposed along an outer shape of the second coil.

11. The coil component as claimed in claim 10, wherein the magnet entirely overlaps a winding area of the first coil.

12. The coil component as claimed in claim 1,
wherein a planar shape of the first coil has a longitudinal direction, and
wherein a position of a coil axis of the second coil is offset from a center position of the first coil in the longitudinal direction to one side in the longitudinal direction.

13. The coil component as claimed in claim 12,
wherein a first opening area surrounded by a winding area of the first coil is elongated in the longitudinal direction, and
wherein a second opening area surrounded by a winding area of the second coil overlaps an end portion of the first opening area on one side in the longitudinal direction.

14. The coil component as claimed in claim 12, wherein a coil axis of the second coil overlaps a winding area of the first coil.

15. A wireless power transmitting device comprising:
a coil component comprising:
a first magnetic body;
a first coil disposed so as to overlap the first magnetic body;
a second coil having an outer size smaller than an outer size of the first coil and disposed so as to overlap the first coil; and
a second magnetic body having an outer size smaller than the outer size of the first coil and disposed between the first and second coils; and
a power transmitting circuit connected to the first and second coils.
